(19) United States
(12) Patent Application Publication
(10) Pub. No.: US 2015/0301493 A1
(43) Pub. Date: Oct. 22, 2015

(54) PRINT TARGET MEDIUM SUPPORT MEMBER AND PRINT TARGET MEDIUM TRANSFER APPARATUS USING THE SAME, AND IMAGE FORMING APPARATUS

(71) Applicant: CASIO COMPUTER CO., LTD., Tokyo (JP)

(72) Inventor: Masashi SAWAI, Tokyo (JP)

(73) Assignee: CASIO COMPUTER CO., LTD., Tokyo (JP)

(21) Appl. No.: 14/664,512

(22) Filed: Mar. 20, 2015

(30) Foreign Application Priority Data
Apr. 17, 2014 (JP) 2014-085554
Feb. 9, 2015 (JP) 2015-023421

(51) Int. Cl. G03G 15/00

(52) U.S. Cl. CPC G03G 15/6552

(57) ABSTRACT

A print target medium support member, which is used in an image forming apparatus having a print target medium placement table where a print target medium is placed and a transfer section which transfers the print target medium placed thereon, including a print target medium rear-end engaging section which engages a rear end of the print target medium such that it is oriented downward and a print target medium intermediate engaging section which engages an intermediate portion between the tip and the rear end of the print target medium, with a first portion from the tip toward rear forming a first curved portion curved such that a surface side forms a convex shape, and with a second portion of the print target medium at the rear of the first curved portion forming a second curved portion curved such that the opposite surface side forms a convex shape.

### CROSS-REFERENCE TO RELATED APPLICATION

This application is based upon and claims the benefit of priority from the prior Japanese Patent Applications No. 2014-085554, filed Apr. 17, 2014 and No. 2015-023421, filed Feb. 9, 2015, the entire contents of which are incorporated herein by reference.

### BACKGROUND OF THE INVENTION

1. Field of the Invention

The present invention relates to a print target medium support member and a print target medium transfer apparatus (paper feeding apparatus) using the print target medium support member, and an image forming apparatus (printer).

2. Description of the Related Art

Conventionally, an image forming apparatus 1 (printer) such as that depicted in FIG. 6 is known. Although not depicted in the drawing, in general, this image forming apparatus 1 uniformly electrifies a photosensitive drum for initialization, performs optical writing on this photosensitive drum to form an electrostatic latent image, converts this electrostatic latent image to a toner image by electrostatic development, transfers the toner image directly or indirectly to a print target medium such as a paper sheet fed from a transfer section 11 of a print target medium transfer apparatus 2 (paper feeding apparatus) for fixing by a fixing unit, and then discharges the print target medium to a paper discharging section 9.

More detailed portions thereof are depicted in FIG. 7. The print target medium transfer apparatus 2 on a side surface of the image forming apparatus 1 is provided with a print target medium placement table 4 (paper-feeding tray unit) that can be freely opened and closed. For positioning a paper sheet in a direction of a paper sheet width according to the paper sheet width, the print target medium transfer apparatus 2 is provided with a pair of side regulating plates 5 so as to be able to move in parallel. Furthermore, the print target medium transfer apparatus 2 is structured so as to allow a normal-sized cut paper sheet exceeding the A4 size to be placed and fed by drawing an extension tray 6.

In recent years, as a print target medium (paper sheet), a long paper sheet different from the standards of a normal-sized cut paper sheet, such as that with one side of a rectangle exceeding a doubled length of the other side thereof (for example, a paper sheet of 297 mm×1200 mm), has been increasingly used. This type of paper is used not in a specific category of business but in wide-ranging categories of business, such as retailing, distribution, food service, educational business, and general offices. For example, in retailing, the long paper sheet is used as a POP (point of purchase) advertisement, sign, or poster for use inside or outside a shop. Furthermore, the long paper sheet is used as a hanging banner or horizontal banner for use in a school, a factory, or a guesthouse, at an event, on a sightseeing bus, or the like. As such, the long paper sheet is used for various use purposes.

These use purposes have a characteristic in which it is desired to immediately print a required small number of sheets in an on-demand manner. Thus, as long paper sheets with a high frequency of use that are available not for professional printing specialists in mass printing but for laymen, those with sizes of 297 mm×900 mm, 297 mm×1200 mm, 210 mm×900 mm and the like are mainly distributed and sold on the market.

When printing is to be performed on a long paper sheet of a size described above, if the long paper sheet is placed on the existing print target medium placement table 4 (paper-feeding tray unit) of the image forming apparatus 1, a rear end of the long paper sheet extending from the print target medium placement table 4 in a longitudinal direction hangs down even if the extension tray 6 is drawn. In addition, because of the weight of the hanging-down portion and a friction force of the paper sheet with the print target medium placement table 4 and the extension tray 6 occurring due to the hanging of the paper sheet, paper sheet transfer is inhibited, thereby possibly causing an error such as inability to transfer the paper sheet from the transfer section 11 deeply toward a paper passage route.

In this case, for normal transfer of the long paper sheet from the transfer section 11, the user is required to perform printing by holding a rear end portion of the long paper sheet so that, for example, the entire long paper sheet is horizontally set, thereby preventing an extending portion of the long paper sheet from hanging down. In this situation, however, operability is extremely low, and an improvement in work efficiency cannot be expected.

In order to solve these problems, for example, a long-paper feeding apparatus for printing on a long paper sheet without paper feeding by hand is disclosed in Japanese Patent Application Laid-Open (Kokai) Publication No. 2004-091211.

However, the long-paper feeding apparatus described in Japanese Patent Application Laid-Open (Kokai) Publication No. 2004-091211 is a paper-feeding tray with a long paper placing surface, and an extremely large placing surface has to be provided in order to hold a long paper sheet having a length of, for example, 1200 mm. Accordingly there is a a problem in that the entire installation area including the size of a paper-feeding tray where a paper sheet is placed and also an image forming apparatus using the long-paper feeding apparatus is greatly increased.

### SUMMARY OF THE INVENTION

The present invention has been conceived in light of the above-described problems. An object of the present invention is to provide a paper-sheet holding member (print target medium support member) where a long paper sheet (print target medium) can be easily placed, a paper-feeding apparatus (print target medium transfer apparatus) using the paper-sheet holding member, and a printer (image forming apparatus).

In accordance with one aspect of the present invention, there is provided a print target medium support member comprising: a mount section which is detachably mounted on an image forming apparatus in a manner to be substantially parallel with a print target medium placement table of the image forming apparatus; and a support section which is detachably mounted on the mount section and supports a rear portion of a print target medium placed on the print target medium placement table.

In accordance with another aspect of the present invention, there is provided a print target medium transfer apparatus comprising: a print target medium placement table where a print target medium is placed; and a print target medium support member which raises a midpoint of a rear portion of the print target medium placed on the print target medium placement table with respect to a direction of feeding the print target medium so as to support from below, and engages a rear end portion of the print target medium hanging down by self weight of the print target medium, with a sag being provided to a raised portion of the print target medium.

In accordance with another aspect of the present invention, there is provided an image forming apparatus comprising: a print target medium placement table where a print target medium is placed; and a print target medium support member which raises a midpoint of a rear portion of the print target medium placed on the print target medium placement table with respect to a direction of feeding the print target medium so as to support from below, and engages a rear end portion of the print target medium hanging down by self weight of the print target medium, with a being sag provided to a raised portion of the print target medium.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

FIG. 1 is an external perspective view according to a first embodiment;

FIG. 2 is a structural view of a print target medium support member 20 according to the first embodiment;

FIG. 3A to FIG. 3C are operational diagrams when the print target medium support member 20 according to the first embodiment is used;

FIG. 4 is a structural view of a print target medium support member 60 according to a second embodiment;

FIG. 5 is a structural view of the print target medium support member 60 according to the second embodiment;

FIG. 6 is an external perspective view of an image forming apparatus 1 including a conventional print target medium transfer apparatus 2; and

FIG. 7 is an external perspective view of a print target medium placement table 4 (paper-feeding tray unit) depicted in FIG. 6.

### DETAILED DESCRIPTION OF THE PREFERRED EMBODIMENTS

Embodiments of the present invention are hereinafter described in detail with reference to the drawings.

### First Embodiment

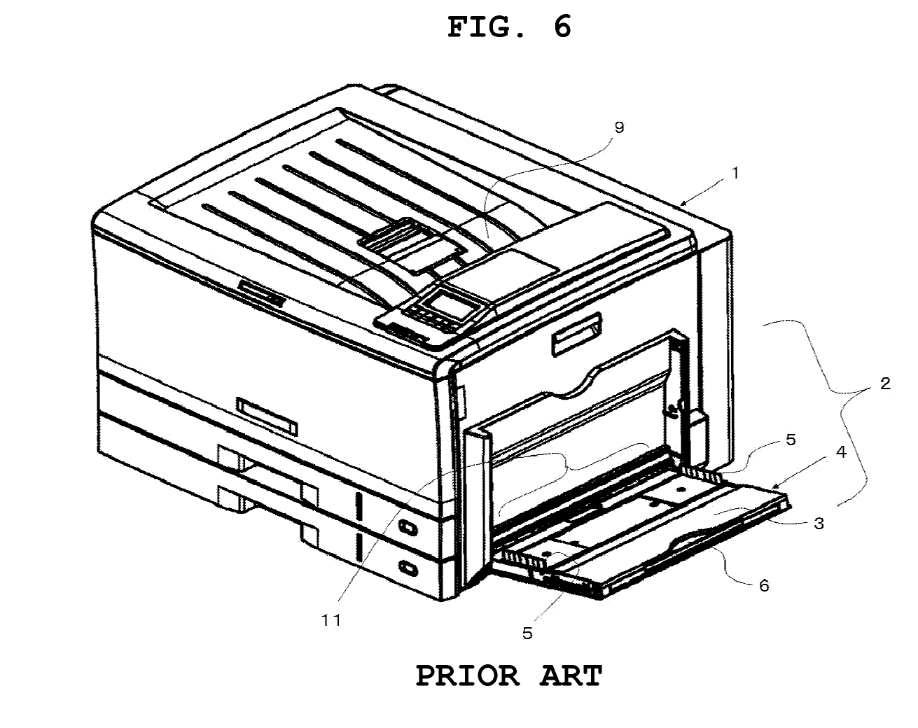

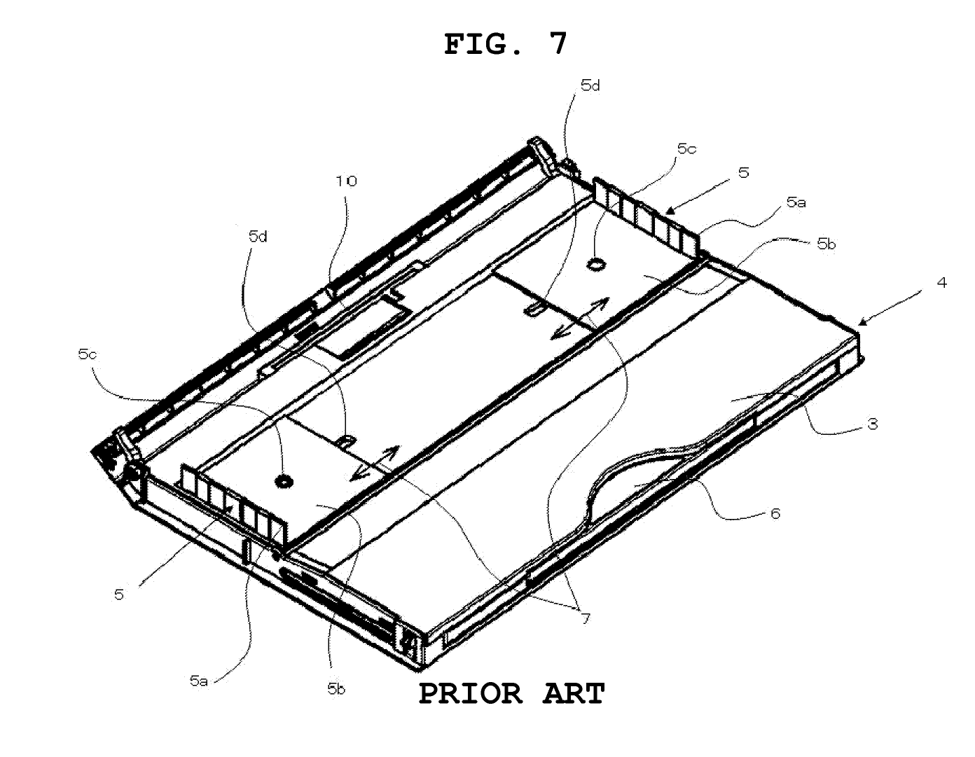

First, a paper feeding method for an image forming apparatus 1 (printer) is described with reference to FIG. 6 and FIG. 7. On one side surface of the image forming apparatus 1, the print target medium transfer apparatus 2 (paper-feeding apparatus) for supplying a print target medium such as a paper sheet with an arbitrary width is provided. The print target medium transfer apparatus 2 is provided with the print target medium placement table 4 (paper-feeding tray unit) that can be freely opened and closed, on which a print target medium is placed. The print target medium placement table 4 is provided with the paired left and right side regulating plates 5, the paper-feeding tray 3, and the extension tray 6.

More specifically, the print target medium placement table 4 is provided with guide holes 5d each for linearly guiding, in directions indicated by arrows 7, a shaft section 5c of each of the paired left and right side regulating plates 5 on the upper surface of the paper-feeding tray 3. Also, although not depicted in the drawings, on a lower surface side of the paper-feeding tray 3, gears engaging with racks described below are rotatably provided each at a position abutting on the center of a relevant one of the paired left and right side regulating plates 5.

The paired left and right side regulating plates 5 each form an L shape having a regulating plate section 5a and a bottom plate section 5b substantially perpendicular to the regulating plate section 5a. Each bottom plate section 5b has the above-described shaft section 5c projecting toward a lower surface side of the bottom plate section 5b. The paired left and right side regulating plates 5 are arranged such that the regulating plate sections 5a face each other substantially in parallel with each other. Each of the shaft sections 5c is inserted into the guide hole 5d. The upper surface of each bottom plate section 5b is used as part of the paper-feeding tray 3.

Although not depicted in the drawings, the racks engaging with the gears are provided to the paired left and right side regulating plates 5. That is, with the cooperation of the gears and the racks, the paired left and right side regulating plates 5 can be moved in parallel and synchronization in directions (arrows 7) substantially orthogonal to a paper-feeding direction.

In the present embodiment, the paired left and right side regulating plates 5 form a width-direction paper holding mechanism, that is, a mechanism for positioning in a paper width direction perpendicular to the paper-feeding direction (paper transfer direction). Also, the extension tray 6 is accommodated under the lower surface of the paper-feeding tray 3, and is structured to be able to feed a paper sheet having a length in the paper-feeding direction (paper transfer direction) up to approximately 500 mm on the print target medium placement table 4, by being drawn.

When printing is to be performed with the above-described conventional structure on a long paper sheet having a length in the paper-feeding direction exceeding 500 mm, if a tip of the paper sheet is engaged with a print target medium tip engaging section 10, the length of the tray is insufficient even though the extension tray 6 is drawn, and the paper sheet may protrude with a rear end portion of the paper sheet hanging down.

In this case, the placed state of the paper sheet becomes unstable, which extremely degrades operability. For example, the long sheet may fall off from a paper-feeding section unless the rear end portion of the paper sheet is held by hand.

Moreover, although there is a method of engaging the tip of the paper sheet with the print target medium tip engaging section 10 and then turning the rear end portion of the paper sheet upward to cover the upper surface of the image forming apparatus 1, the degree of a curve of the paper sheet from the print target medium transfer apparatus 2 (paper-feeding apparatus) is not constant, and therefore the paper-feeding state is changed every time. This may cause the paper-feeding performance to fluctuate, which is not preferable.

Furthermore, in the paper feeding method described above, when a plurality of print target mediums are simultaneously placed, a fed print target medium may drag another stacked print target medium, which increases the possibility of occurrence of multi feeding or paper jamming. That is, the possibility of simultaneously placing a plurality of print target mediums is precluded.

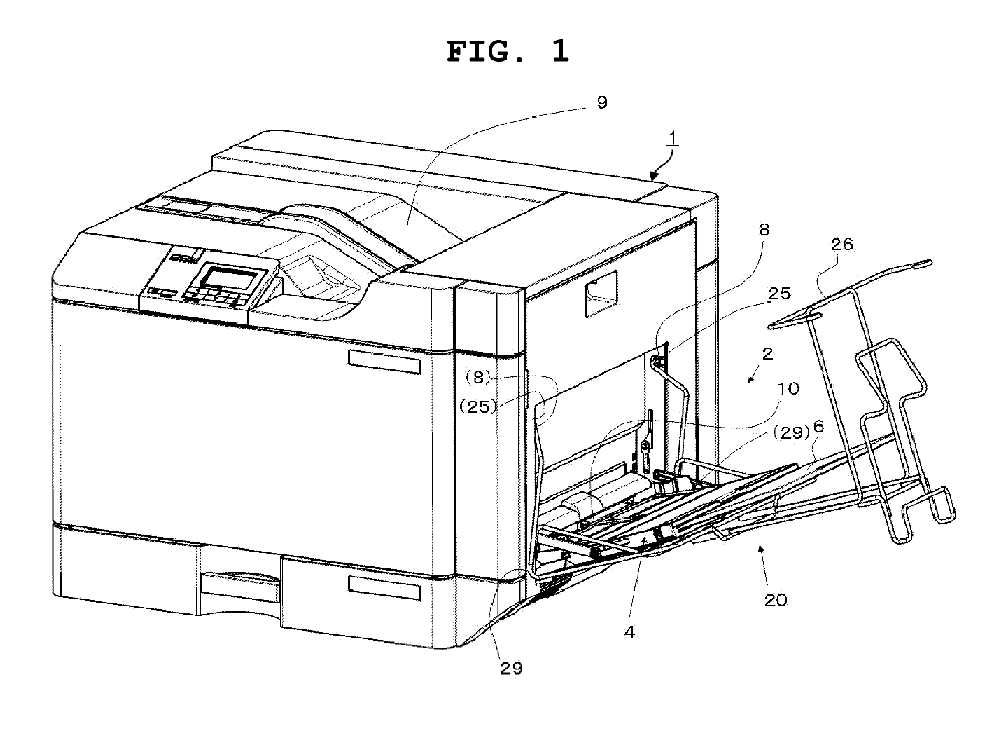

FIG. 1 depicts a first embodiment of the present invention. Note that portions in the image forming apparatus 1, the print target medium transfer apparatus 2 (paper-feeding apparatus), and the print target medium placement table 4 (paper-feeding tray unit) which are common to those depicted in FIG. 6 and FIG. 7 are not described herein and equivalent portions are provided with the same reference numerals as those in FIG. 6 and FIG. 7.

FIG. 1 depicts a state where the extension tray 6 incorporated in the print target medium placement table 4 of the print target medium transfer apparatus 2 has been drawn and a print target medium support member 20 has been mounted.

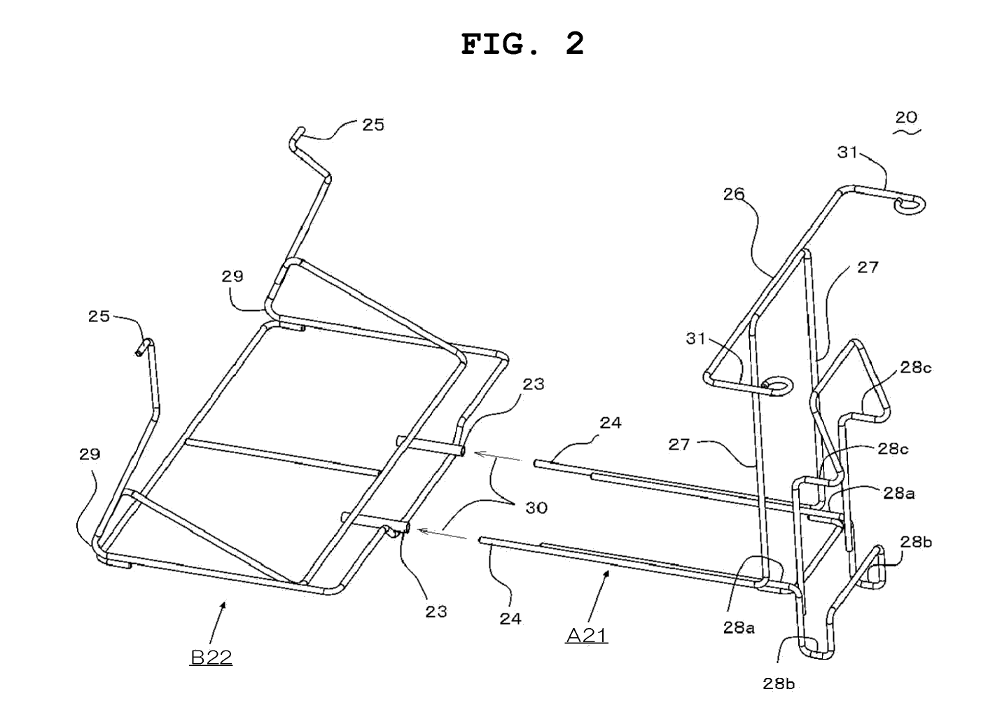

Details of the print target medium support member 20 are depicted in FIG. 2. The print target medium support member 20 is constituted by two members, that is, a partially-welded part A21 (support section) made of a wire material and a part B22 (mount section) having a member made of a wire material and pipe members 23 welded thereto. This print target medium support member 20 is structured to have a symmetrical shape with reference to the center of a paper sheet, with inserting sections 24 of the part A21 (support section) being inserted into the pipe members 23 of the part B22 (mount section) so as to have a length freely adjustable in a direction of arrows 30 in a light press-fitted state.

The wire material, which is a material with a steel wire plated with nickel, is excellent in aesthetic appearance, smoothness, strength, and durability, and has a frame structure which achieves weight reduction in contrast to its size.

FIG. 1 depicts a standard assembled state. Insertion mounting sections 25 of the print target medium support member 20 are inserted into hook holes 8 on an image forming apparatus 1 side by the resilient deformation of the wire, and abutting sections 29 abut on a surface of the print target medium transfer apparatus 2 (one side surface of the image forming apparatus 1), whereby the entire print target medium support member 20 is held.

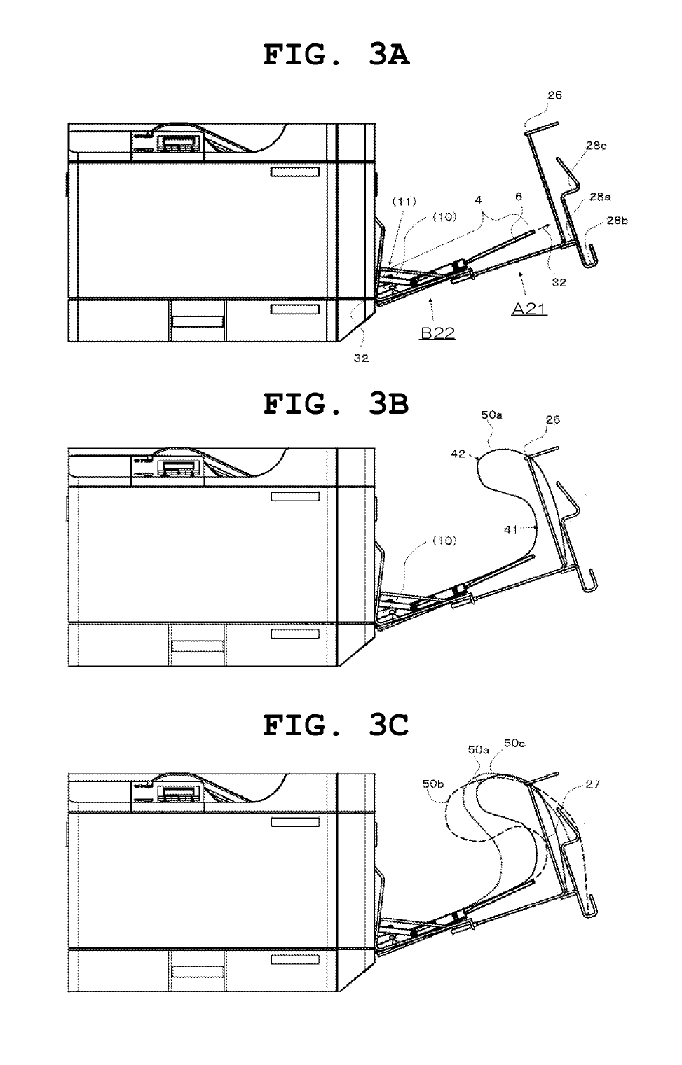

The print target medium support member 20 is removably mounted, and therefore can be installed only when a long paper sheet is used as a print target medium. When the print target medium support member 20 is to be used, the extension tray 6 is drawn in a direction indicated by an arrow 32 in FIG. 3A.

By the inserting sections 24 being deeply (or shallowly) inserted, the part A21 (support section) further approaches (or moves away from) the image forming apparatus 1. As a result, for example, a paper sheet shorter (or longer) than general long paper sheets with a high frequency of use such as those of 900 mm and 1200 mm can be supported, and various fine degrees of hardness (paper hardness) of the print target mediums (paper sheets) can be supported.

Here, the structure of the print target medium support member 20 is described in detail. The part B22 (mount section) includes the insertion mounting sections 25 for being removably attached to the hook holes 8 of the image forming apparatus 1 so as to be substantially parallel with the print target medium placement table 4 on the lower side of the print target medium placement table 4 of the print target medium transfer apparatus 2.

The part A21 (support section) includes boundary members (raising sections) made of a wire material standing substantially vertically from the wire material forming the inserting sections 24 substantially in parallel with the print target medium placement table 4.

The part A21 (support section) also includes a print target medium intermediate engaging section 26. With a long paper sheet being placed on the print target medium placement table 4, the tip of the long paper sheet being engaged with the print target medium tip engaging section 10, and a rear portion of the long paper sheet being raised in the paper-feeding direction, the print target medium intermediate engaging section 26 supports the long paper sheet from below at a midpoint at a further rear portion of the long paper sheet. That is, the boundary members 27 (raising sections) have a structure of supporting the print target medium intermediate engaging section 26.

The boundary members 27 (raising sections) raise, with respect to the paper-feeding direction, a rear portion of the long paper sheet placed on the print target medium placement table 4 extending from the print target medium placement table 4. The print target medium intermediate engaging section 26 supports the raised long paper sheet from below at a midpoint.

Also, the boundary members 27 (raising sections) have at least one member made of a wire material within a minimum paper width (a width of a paper sheet in a direction perpendicular to the paper-feeding direction) among those of long paper sheets of sizes usable for printing in the image forming apparatus 1. This member abuts on the long paper sheet raised with respect to the paper-feeding direction so as to restrict a rearward movement of the long paper sheet (in a direction opposite to the transfer direction).

That is, in the image forming apparatus 1 of the present embodiment in the example of FIG. 2, any of paper sheets of different sizes is fed and transferred with the center of its paper sheet width placed at the same position. Accordingly, the boundary members 27 (raising sections) in FIG. 2 are constituted by wire materials each located away from a reference position where the center of the paper sheet width is located, by the same distance so as to have a symmetrical shape with reference to that reference position.

Note that the positions and number of wire materials structured as the boundary members 27 (raising sections) may be as follows. For example, one wire material may be located at the reference position where the center of the paper sheet width is located, and at least two wire materials may be each located away by a predetermined space in the paper sheet width direction (that is, at least three wire materials in total may be provided). In this case, since one wire material is located at the reference position, a rearward movement of the long paper sheet (in a direction opposite to the paper-feeding direction) can be restricted. Thus, the positions of the other wire materials located away by the predetermined space are not required to be within the minimum paper sheet width among those of the long paper sheets of the usable sizes, and any structure can be adopted as long as the structure stably supports the print target medium intermediate engaging section 26.

The print target medium intermediate engaging section 26 is constituted by one wire material, and includes a pair of bent sections 31 which is formed by bending both ends of the wire material rearward at substantially 90 degrees, and having a space larger than the paper sheet width of a long paper sheet usable by the image forming apparatus 1 (a width in a direction perpendicular to the paper-feeding direction). These bent sections 31 are raised upward by the print target medium intermediate engaging section 26 to prevent the long paper sheet hanging downward from the print target medium intermediate engaging section 26 from being shifted in the paper sheet width direction (lateral direction).

Also, the part A21 (support section) includes a plurality of print target medium rear-end engaging sections 28a, 28b, and 28c welded to the wire materials constituting the inserting sections 24, the boundary members 27 (raising sections), and the like. These print target medium rear-end engaging sections 28a, 28b, and 28c are raised upward by the print target medium intermediate engaging section 26 and the boundary members 27 (raising sections), and the print target medium intermediate engaging section 26 supports a rear end portion of the long paper sheet hanging down by the self weight of the paper sheet.

The print target medium rear-end engaging sections 28a and 28b are formed by bending one wire material to be shaped such that the print target medium rear-end engaging section 28a is located at a relatively high position and the print target medium rear-end engaging section 28b is located at a relatively low position. Also, the print target medium rear-end engaging section 28c is formed by bending one wire material welded to the wire material forming the print target medium rear-end engaging sections 28a and 28b so that a portion thereof supports a rear end portion of the long paper sheet, and shaped such that the print target medium rear-end engaging section 28c is located at a relatively highest position with respect to the print target medium rear-end engaging sections 28a and 28b.

FIG. 3B depicts a method of placing a long paper sheet on the print target medium transfer apparatus 2 (paper-feeding apparatus) using the print target medium support member 20 serving as an embodiment of the present invention, with a plain paper sheet 50a having the long length of 900 mm as an example.

The tip of a print target medium 50 (paper sheet), which is the plain paper sheet 50a having a long length of 900 mm, is engaged with the print target medium tip engaging section 10 along the placing surface of the print target medium placement table 4 without buckling in a manner similar to that when a normal cut paper sheet of a standard size (such as a paper sheet smaller than the A3 size).

Subsequently, a first portion of the print target medium 50 located from its tip toward rear in the paper-feeding direction forms a first curved portion 41 curved such that a surface side placed on the print target medium placement table 4 forms a convex shape in the first portion. Furthermore, a second portion of the print target medium 50 located at the rear of the first curved portion 41 forms a second curved portion 42 curved such that a surface side opposite to the above-described surface side forms a convex shape in the second portion. In this state, an intermediate portion between the tip of the print target medium 50 and the rear end thereof in the paper-feeding direction is engaged with the print target medium intermediate engaging section 26.

Then, finally, the rear end of the print target medium 50 is engaged with the print target medium rear-end engaging section 28a such that the rear end of the print target medium 50 is oriented downward.

The positions of the print target medium intermediate engaging section 26 and the print target medium rear-end engaging section 28a are set such that the rear end of the print target medium 50 is engaged by the self weight of the print target medium 50 without falling off from the print target medium rear-end engaging section 28a.

The plurality of print target medium rear-end engaging sections 28 are prepared depending on differences in length and thickness of the print target medium 50 or the hardness (paper hardness) of the print target medium 50. The print target medium rear-end engaging section 28a, the print target medium rear-end engaging section 28b, and the print target medium rear-end engaging section 28c hold the rear end of the print target medium 50 so as to support the plain paper sheet 50a having the long length of 900 mm, a plain paper sheet 50b having a long length of 1200 mm, and a paperboard 50c having a long length of 900 mm, respectively.

Here, from among the print target mediums 50, when a paper sheet that is long in the paper-feeding direction such as the plain paper sheet 50b having the long length of 1200 mm is used, the first curved portion 41 is pushed and moved to a rear end direction (a rightward direction in FIG. 3B) by the weight of a portion of the paper sheet on the periphery of the second curved portion 42, and the second curved portion 42 is moved down to the upper surface of a forward portion of the paper sheet itself present on the placing surface of the print target medium placement table 4, whereby the print target medium 50 may come in contact with itself. If the paper sheet is fed in this state, the second curved portion 42 is dragged to the contacting forward portion of the paper sheet itself, and the paper sheet is fed from the transfer section 11 with the second curved portion 42 being in contact therewith, and drawn into a paper passage route inside the image forming apparatus 1, whereby a non-desirable situation including a damage to the inside of the image forming apparatus 1 such as paper jamming may be created.

Thus, in the present invention, the boundary members 27 (raising sections), which are also members for supporting the print target medium intermediate engaging section 26, play a role of preventing the above-described self contact.

From among the print target mediums 50, when a paper sheet that is long (long paper sheet) particularly in the paper-feeding direction such as the plain paper sheet 50b having the long length of 1200 mm is used, the sizes of the first curved portion 41 and the second curved portion 42 are increased. By the weight of a portion of the paper sheet on the periphery of the second curved portion 42 formed by the long paper sheet, the first curved portion 41 moves in the rear end direction (the rightward direction in FIG. 3B). and eventually abuts on the boundary members 27 (raising sections), whereby the movement of the first curved portion 41 is stopped. As a result, the first curved portion 41 can support the weight of the paper sheet on the periphery of the second curved portion 42, and prevents the second curved portion 42 from making self contact with the print target medium 50 on the placing surface of the print target medium placement table 4.

FIG. 3C depicts the state of each type of long paper sheet as the print target medium 50 placed by type.

Next, the state in which the print target medium 50 has been placed in this manner is described in detail.

In a manner similar to that for a normal cut paper sheet of a standard size (such as a paper sheet smaller than the A3 size), the tip of the print target medium 50 is engaged with the print target medium tip engaging section 10 of the image forming apparatus 1, and the print target medium 50 is set along the placing surface of the print target medium placement table 4 without buckling. That is, the approach posture is precisely identical to that of the normal cut paper sheet of the standard size, and the paper-feeding capability is unchanged and is precisely equal to that for the normal cut paper sheet of the standard size. Therefore, it is not required to prepare a paper-feeding pressure changing section or the like dedicated to long paper sheets.

Also, the force from the first curved portion 41 acting on the tip of the print target medium 50 engaged with the print target medium tip engaging section 10 relates to the weight of the paper sheet up to the print target medium intermediate engaging section 26, and is a force in a pressing direction within a range in which the print target medium 50 is not buckled toward the print target medium tip engaging section 10. Therefore, a user operation such as holding the print target medium 50 by hand so as not to cause the tip of the print target medium 50 to fall off is not required, and excellent operability can be achieved.

A portion of the print target medium 50 from a portion along the placing surface of the print target medium placement table 4 to a portion immediately in front of the first curved portion 41 supports a certain ratio of the weight of the paper sheet of the first curved portion 41 and the second curved portion 42 up to the print target medium intermediate engaging section 26, by the placing surface of the print target medium placement table 4.

Accordingly, the portion immediately in front of the first curved portion 41 in the portion along the placing surface of the print target medium placement table 4 has a slightly high pressure and also a slightly high frictional force between the print target medium 50 and the placing surface of the print target medium placement table 4.

Although this frictional force serves as resistance force at the time of paper feeding, it does not pose any problem even when the weight of the print target medium 50 is taken into consideration because the coefficient of friction is sufficiently small as long as the print target medium placement table 4 is made of a resin material (for example, an ABS (Acrylonitrile Butadiene Styrene)+PC (Polycarbonate) alloy resin) for use as a general tray.

The weight of the paper sheet of the certain ratio at the intermediate portion between the tip of the print target medium 50 and the rear end in the paper-feeding direction is supported by the print target medium intermediate engaging section 26.

When a long paper sheet is transferred for paper feeding, a portion of the paper sheet positioned to rearward of the print target medium intermediate engaging section 26 in the paper-feeding direction moves while rubbing the print target medium intermediate engaging section 26. However, since the print target medium intermediate engaging section 26 is a steel wire surface-treated with durably hard nickel plating, the coefficient of friction is small, and the paper sheet can smoothly pass through.

When the print target medium 50 is the plain paper sheet 50a having the long length of 900 mm, and this print target medium 50 is placed on the print target medium transfer apparatus 2, a midpoint of the paper sheet surmounts the print target medium intermediate engaging section 26, and then the rear end of the print target medium 50 in the paper-feeding direction hangs approximately downward and is engaged with the print target medium rear-end engaging section 28a.

In order to engage the rear end of the print target medium 50, the print target medium rear-end engaging section 28a is constituted by a member for supporting from a downward direction (a direction of being pulled by gravity) and a member for regulating a direction opposite to the paper-feeding direction (rightward direction in FIG. 3B), the paper-feeding direction (leftward direction in FIG. 3B) or both of the paper-feeding and its opposite directions (leftward and rightward directions in FIG. 3B) as required.

The position of the print target medium rear-end engaging section 28a is set so as to exert the weight of the paper sheet at the certain ratio of the weight of the rear end portion of the print target medium 50 onto the member for supporting from the downward direction. Therefore, the rear end portion of the print target medium 50 does not spontaneously fall off the print target medium rear-end engaging section 28a, a user operation such as holding the print target medium 50 by hand so as not to cause the rear end portion to fall off is not required, and excellent operability can be achieved.

In a series of operations of engaging the tip of the plain paper sheet 50a having the long length of 900 mm with the print target medium tip engaging section 10, setting the paper sheet along the placing surface of the print target medium placement table 4, forming the first curved portion at a midpoint portion of the paper sheet (long paper sheet), forming the second curved portion with an inverted curve of the first curved portion, and then engaging the rear end of the print target medium 50 in the paper-feeding direction with the print target medium rear-end engaging section 28a, the plain paper sheet 50a having the long length of 900 mm is formed in a substantially S shape (viewed from front in FIG. 3B), and the long paper sheet is not wound round.

Therefore, at the initial stage of the placement of the paper sheet, the tip of the plain paper sheet 50a having the long length of 900 mm is engaged with the print target medium tip engaging section 10, and the paper sheet (long paper sheet) is handled by pinching the rear end portion of the print target medium 50 with fingers. Then, the rear end portion of the long paper sheet can be engaged with the print target medium rear-end engaging section 28a without requiring the switching of the hand pressing the paper sheet (long paper sheet). Accordingly, the placing stability of the print target medium 50 is excellent.

Also, depending on the type of the print target medium 50, not only one but several sheets can be stacked. As a matter of course, the procedure of placing the print target medium 50 may be started from a paper rear end side or a midpoint of the print target medium 50.

Next, a paper feeding operation is described by using the front view in FIG. 3B with the plain paper sheet 50a having the long length of 900 mm placed as described above as an example.

When the transfer section 11 of the print target medium transfer apparatus 2 of the image forming apparatus 1 starts a paper feeding operation (paper sheet transfer), the plain paper sheet 50a having the long length of 900 mm engaged with the print target medium tip engaging section 10 is fed from its tip, and is drawn into the paper passage route inside the image forming apparatus 1.

Initially, the rear end of the print target medium 50 does not move. As the paper sheet transfer, the first curved portion 41 first moves to the direction of the image forming apparatus 1 and thereby straighten curves of the first curved portion 41 and the second curved portion 42.

Then, a paper sheet portion in front of the print target medium intermediate engaging section 26 is shortened, an intermediate portion of the long paper sheet slides over the print target medium intermediate engaging section 26, and a paper sheet portion subsequent to the print target medium intermediate engaging section 26 starts to move.

In the course of time, the rear end of the plain paper sheet 50a having the long length of 900 mm falls off the print target medium rear-end engaging section 28a and rises such that it is floated. Here, the posture of the plain paper sheet 50a having the long length of 900 mm from the transfer section 11 along the placing surface of the print target medium placement table 4 is not changed, and an impact by the movement of the rear end of the plain paper sheet 50a having the long length of 900 mm is small. Therefore, the paper feeding operation is not influenced.

Then, when the paper feeding operation (paper sheet transfer) further proceeds, the curve of the second curved portion 42 is completely straightened, and only the first curved portion 41 is left on the paper sheet left to rearward of the print target medium placement table 4 at the rear of the transfer section 11. Subsequently, only a portion along the print target medium placement table 4 is left on the paper sheet after paper transfer. Eventually, the entire plain paper sheet 50a having the long length of 900 mm is completely drawn into the paper passage route inside the image forming apparatus 1.

In the first embodiment, the types of the print target medium 50 include the plain paper sheet 50a having the long length of 900 mm, the plain paper sheet 50b having the long length of 1200 mm, and the paperboard 50c having the long length of 900 mm, byway of example. However, since the print target medium support member 20 has the inserting sections 24 of the part A21 (support sections) inserted into the pipe members 23 of the part B22 (mount sections) such that the inserting sections 24 have a length freely adjustable with light press-fitting, the position of the print target medium intermediate engaging section 26 can be adjusted according to the characteristics of the print target medium 50, and the print target mediums 50 in a wider range of characteristics can be supported.

Note that, although each inserting section 24 depicted in FIG. 2 has been formed such that it is inserted by an amount equivalent to the length of the pipe member 23 and not inserted further, the change amount of the position of the print target medium intermediate engaging section 26 can be increased by changing the shape of the inserting section 24 as appropriate such that the inserting section 24 has a shape that allows further penetration more than the length of the pipe member 23 for deep insertion.

### Second Embodiment

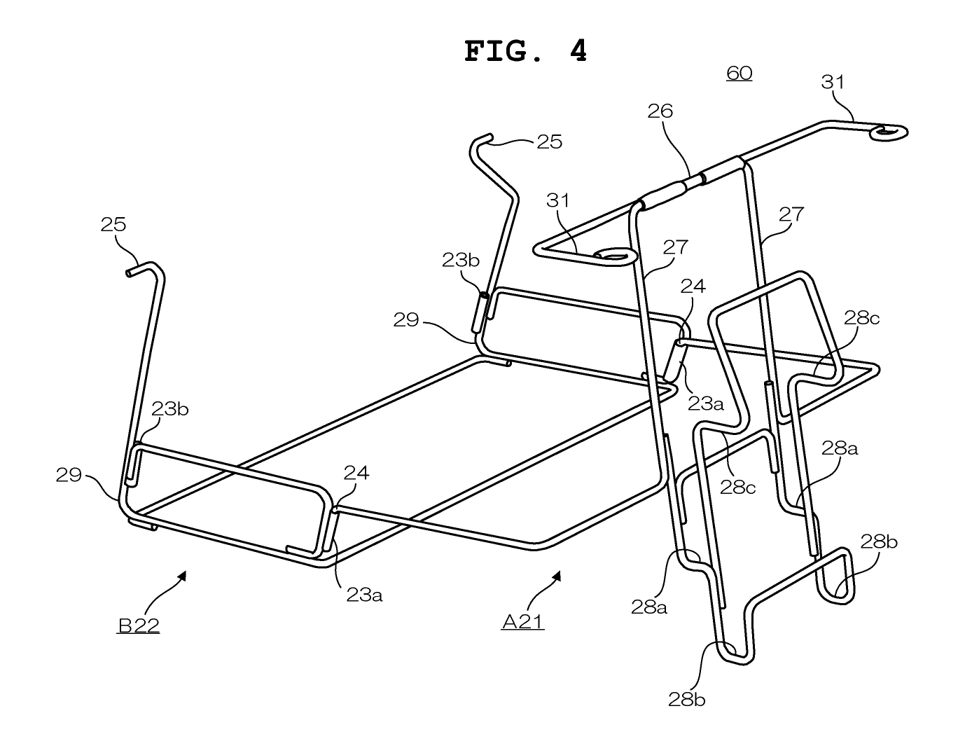

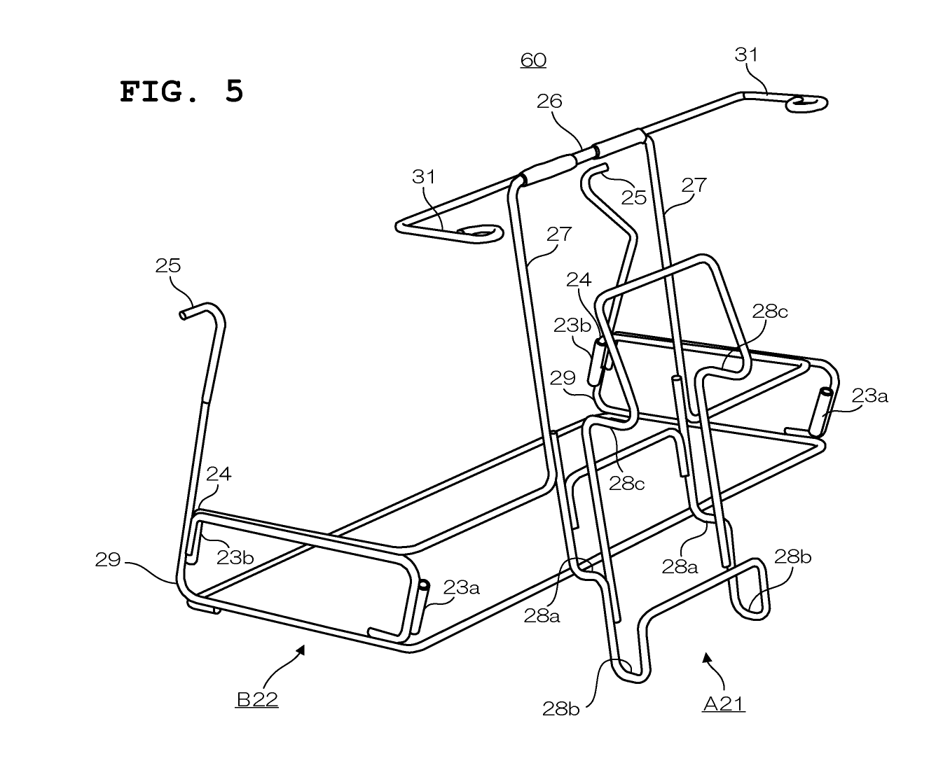

Details of a print target medium support member 60 are depicted in FIG. 4 and FIG. 5. Note that members having the same functions as those of the print target medium support member 20 of the first embodiment depicted in FIG. 2 are provided with the same reference numerals and are not described herein. As with the first embodiment, the print target medium support member 60 according to a second embodiment is constituted by two members, that is, a part A21 (support section) made of a partially-welded wire and a part B22 (mount section) with a member made of a wire material and pipe members 23a and 23h welded together.

With the insertion mounting sections 25 being held and inserted into the hook holes 8 of the image forming apparatus 1, the pipe members 23a are mounted on the part B22 (mount section) at positions away from abutting sections 29, and the pipe members 23b are mounted each near the abutting section 29 on the image forming apparatus 1 side.

The inserting sections 24 of the part A21 (support sections) are each inserted into either one of the pipe members 23a and 23b of the part B22 (mount section) in a light press-fitted state so as to have a symmetrical shape with reference to the center of the paper sheet.

In an example depicted in FIG. 4, the state is depicted in which the inserting sections 24 of the part A21 (support section) have been inserted into the pipe members 23a of the part B22 (mount section) in a light press-fitted state. In an example depicted in FIG. 5, the state is depicted in which the inserting sections 24 of the part A21 (support section) have been inserted into the pipe members 23b of the part B22 (mount section) in a light press-fitted state.

As such, in the second embodiment, by the inserting sections 24 being inserted into the pipe members 23a of the part B22 (mount section) as depicted in FIG. 4, for example, general long paper sheets having a length of 900 mm, 1200 mm, or the like with a high frequency of use can be supported.

On the other hand, by the inserting sections 24 being inserted into the pipe members 23b of the part B22 (mount section) as depicted in FIG. 5, the part A21 (support section) further approaches the image forming apparatus 1. Accordingly, for example, a paper sheet with a length shorter than the general long paper sheets with a length of 900 mm, 1200 mm, and the like with a high frequency of use can also be supported. In addition, various fine degrees of hardness (paper hardness) of the print target medium (paper sheet) can also be supported.

A method of placing a long paper sheet in the print target medium transfer apparatus 2 (paper feeding apparatus) using the print target medium support member 60 of the second embodiment of the present invention is similar to that of the first embodiment described above (refer to FIGS. 3A to 3C), and therefore is not described herein.

Note that, although the pipe members 23 into which the inserting sections 24 are inserted are located at two positions 23a and 23b (two pairs), more pipe members 23 can be provided so as to be finely spaced apart from each other from a position nearest to the abutting section 29 to a position farthest thereto, whereby the position of the print target medium intermediate engaging section 26 can be finely adjusted.

Also note that, in the above-described embodiments (first and second embodiments), an elastic member such as that made of rubber may be wound around a portion of the print target medium intermediate engaging section 26 to adjust the coefficient of friction when a portion of the paper sheet positioned rearward of the print target medium intermediate engaging section 26 in the paper-feeding direction is transferred (refer to FIG. 4 and FIG. 5). By this structure, adjustment when a plurality of print target mediums (paper sheets) have been placed is possible so as to prevent a paper sheet in contact with the lower side of the print target medium intermediate engaging section 26 from being dragged by a paper sheet on the upper side that is fed and transferred. Furthermore, even with a fine difference in the hardness (paper hardness) of the placed print target medium (paper sheet) and a difference in the length of the paper sheet, adjustment is possible so as to cause the paper sheet sliding along the print target medium intermediate engaging section 26 for transfer to be transferred with an assumed speed and timing.

Also note that, in the above-described embodiments (first and second embodiments), the dimensions of each section of the part A21 (support section) may be changed as appropriate according to a fine difference in the hardness of the placed print target medium or a difference in the length thereof, or each section of the part A21 (support section) may have a retractable structure. That is, the dimension of a portion from the inserting sections 24 to the boundary members 27 (raising sections) in the paper-feeding direction may be changed as appropriate or this portion may have a retractable structure. Moreover, the dimension of each boundary member (raising section) supporting the print target medium intermediate engaging section 26 supporting a long paper sheet from below may be changed as appropriate, or this portion may have a retractable structure, whereby the position of the print target medium intermediate engaging section 26 in a height direction can be adjusted. Furthermore, the positions of the plurality of print target medium rear-end engaging sections 28a, 28b, and 28c may be changed as appropriate, or these sections 28a, 28b, and 28c may be changed with a retractable structure. Also, the number of print target medium rear-end engaging sections 28 may be increased or decreased.

While the present invention has been described with reference to the preferred embodiments, it is intended that the invention be not limited by any of the details of the description therein but includes all the embodiments which fall within the scope of the appended claims.

What is claimed is:

1. A print target medium support member comprising:
a mount section which is detachably mounted on an image forming apparatus in a manner to be substantially parallel with a print target medium placement table of the image forming apparatus; and
a support section which is detachably mounted on the mount section and supports a rear portion of a print target medium placed on the print target medium placement table.

2. The print target medium support member according to claim 1, wherein the support section comprises a raising section which raises the rear portion of the print target medium placed on the print target medium placement table with respect to a paper-feeding direction toward the image forming apparatus; a print target medium intermediate support section which supports the print target medium raised by the raising section from below; and a print target medium rear-end engaging section which engages a rear end portion of the print target medium hanging down from the print target medium intermediate support section by self weight of the print target medium, with a sag being provided to a raised portion of the print target medium.

3. The print target medium support member according to claim 2, wherein a plurality of print target medium rear-end engaging sections are provided at different heights so as to support the rear end portion of the print target medium according to a length and/or a hardness of the print target medium.

4. The print target medium support member according to claim 3, wherein the raising section has at least one structure within a width of the print target medium in a direction perpendicular to the paper-feeding direction so as to restrict front-and-rear movement of a front portion of the raised print target medium in the paper-feeding direction.

5. The print target medium support member according to claim 4, wherein the print target medium intermediate support section comprises a pair of bent sections formed by both ends of the print target medium intermediate support section being bent rearward at substantially 90 degrees and having a space larger than the width of the print target medium.

6. The print target medium support member according to claim 5, wherein the support section is structured to be retractable so as to allow a change of one or more of a position of the print target medium intermediate support section, a position of the print target medium rear-end engaging section, and a position of the raising section according to the length and/or the hardness of the print target medium.

7. The print target medium support member according to claim 2, wherein the raising section has at least one structure within a width of the print target medium in a direction perpendicular to the paper-feeding direction so as to restrict a front-and-rear movement of a front portion of the raised print target medium in the paper-feeding direction.

8. The print target medium support member according to claim 7, wherein the print target medium intermediate support section comprises a pair of bent sections formed by both ends of the print target medium intermediate support section being bent rearward at substantially 90 degrees and having a space larger than the width of the print target medium.

9. The print target medium support member according to claim 8, wherein the support section is structured to be retractable so as to allow a change of one or more of a position of the print target medium intermediate support section, a position of the print target medium rear-end engaging section, and a position of the raising section according to a length and/or a hardness of the print target medium.

10. The print target medium support member according to claim 2, wherein the print target medium intermediate support section comprises a pair of bent sections formed by both ends of the print target medium intermediate support section being bent rearward at substantially 90 degrees and having a space larger than a width of the print target medium.

11. The print target medium support member according to claim 10, wherein the support section is structured to be retractable so as to allow a change of one or more of a position of the print target medium intermediate support section, a position of the print target medium rear-end engaging section, and a position of the raising section according to a length and/or a hardness of the print target medium.

12. The print target medium support member according to claim 2, wherein the support section is structured to be retractable so as to allow a change of one or more of a position of the print target medium intermediate support section, a position of the print target medium rear-end engaging section, and a position of the raising section according to a length and/or a hardness of the print target medium.

13. The print target medium support member according to claim 3, wherein the print target medium intermediate support section comprises a pair of bent sections formed by both ends of the print target medium intermediate support section being bent rearward at substantially 90 degrees and having a space larger than a width of the print target medium.

14. The print target medium support member according to claim 13, wherein the support section is structured to be retractable so as to allow a change of one or more of a position of the print target medium intermediate support section, a position of the print target medium rear-end engaging section, and a position of the raising section according to the length and/or the hardness of the print target medium.

15. The print target medium support member according to claim 3, wherein the support section is structured to be retractable so as to allow a change of one or more of a position of the print target medium intermediate support section, a position of the print target medium rear-end engaging section, and a position of the raising section according to the length and/or the hardness of the print target medium.

16. The print target medium support member according to claim 4, wherein the support section is structured to be retractable so as to allow a change of one or more of a position of the print target medium intermediate support section, a position of the print target medium rear-end engaging section, and a position of the raising section according to the length and/or the hardness of the print target medium.

17. The print target medium support member according to claim 7, wherein the support section is structured to be retractable so as to allow a change of one or more of a position of the print target medium intermediate support section, a position of the print target medium rear-end engaging section, and a position of the raising section according to a length and/or a hardness of the print target medium.

18. A print target medium transfer apparatus comprising:
a print target medium placement table where a print target medium is placed; and
a print target medium support member which raises a midpoint of a rear portion of the print target medium placed on the print target medium placement table with respect to a direction of feeding the print target medium so as to support from below, and engages a rear end portion of the print target medium hanging down by self weight of the print target medium, with a sag being provided to a raised portion of the print target medium.

19. An image forming apparatus comprising:
a print target medium placement table where a print target medium is placed; and
a print target medium support member which raises a midpoint of a rear portion of the print target medium placed on the print target medium placement table with respect to a direction of feeding the print target medium so as to support from below, and engages a rear end portion of the print target medium hanging down by self weight of the print target medium, with a being sag provided to a raised portion of the print target medium.
